(19) United States
(12) Patent Application Publication
(10) Pub. No.: US 2018/0091449 A1
(43) Pub. Date: Mar. 29, 2018

(54) EVENT-DRIVEN POLICY-BASED DISTRIBUTED CONTAINER MANAGEMENT SYSTEM

(71) Applicant: Telefonaktiebolaget LM Ericsson (publ), Stockholm (SE)

(72) Inventors: Juan TELLEZ, Oakland, CA (US); Shobhit AGARWAL, Fremont, CA (US); Shatrugna SADHU, San Francisco, CA (US)

(21) Appl. No.: 15/463,977

(22) Filed: Mar. 20, 2017

Related U.S. Application Data
(60) Provisional application No. 62/400,044, filed on Sep. 26, 2016.

(51) Int. Cl. H04L 12/58; H04L 5/14; H04L 29/08

(52) U.S. Cl. CPC H04L 51/04; H04L 67/22; H04L 51/16; H04L 5/14

(57) ABSTRACT

A system and method implements an event service of a platform. The platform executes a set of containers and component services to support the set of containers. The method tracks subscribers for events and facilitates distribution of the events to the subscribers. The events include information about changes to the state of at least one of the set of containers, where subscribers are processes in communication with the platform. The method includes receiving, at the event service, a subscriber request to subscribe for events of a container from the set of containers, receiving, at the event service, an event from a component service in the set of component services of the platform, and sending, by the event service, the event to the subscriber.

### CROSS-REFERENCE TO RELATED APPLICATIONS

This application claims the benefit of U.S. Provisional Application No. 62/400,044, filed Sep. 26, 2016, which is hereby incorporated by reference.

### TECHNICAL FIELD

Embodiments of the invention relate to the field of event notifications in a platform providing a container management system; and more specifically, to the handling of real-time event notifications related to containers in the container management systems.

### BACKGROUND

A platform is an operating environment that may execute on physical and/or virtualized hosts. A physical host is a traditional computing system having physical hardware and an operating system. Virtual hosts are operating environments based on the virtualization of the physical hardware. Virtualization in the area of computing systems is the creation of a virtual (rather than physical) representation of some aspect of the computing system. Operating system level virtualization is an example of virtualization where a server is virtualized often to provide more secure hosting environments in server farm, datacenter, cloud computing or similar distributed computing systems. Operating system level virtualization can securely manage fixed physical computing system resources amongst a set of users. These users may be from competing entities and thus need to have secured execution environments to prevent the other users from gaining access to our interfering with their programs.

A platform can be used to manage a set of separate operating environments as containers, virtualization engines or similar instances. The platform manages the physical computing system resources amongst the set of operating environments. The management of resources can be referred to as a container management system that enables any number of containers or similar entities to execute over any number of physical or virtual hosts as part of the platform.

Applications running on the platform are executed within containers or similar entities managed by the platform. The containers are a mechanism where applications can be controlled to limit the amount of computing resources utilized by the application during execution. The containers are isolated and controlled lightweight processes running on an operating system or hypervisor. The operating system may be implemented by a physical or virtual host. The containers and the applications they run do not have access to any information about other processes of the host. A container is restricted to a limited set of resources including processor(s), memory, fixed storage and similar resources. The container may be allotted a fixed set of such resources when it is instantiated.

The use of containers provides advantages for running application. The containers can share runtime code with their host operating system and other containers. This makes the containers lightweight (i.e., low resource) and portable such that a large number of containers can run across many hosts as a distributed system and the containers can be moved between hosts for load balancing of the available resources across the set of hosts. However, such distribution and movement of containers across a set of hosts makes the monitoring of the condition and life cycle of the containers more difficult.

The platforms manage and monitor the containers in this distributed environment, which may include thousands of containers running across hundreds of physical and/or virtual hosts. To monitor the status of the containers the platforms and in particular the container management system of the platforms may use a centralized system where everything about the managed containers can be known. These systems can provide properly authenticated and authorized access to the current state of any given container or application running in a container when queried. In other systems, an event stream is generated by the platform to provide information about containers and applications. These event streams provide notifications to interested internal control clients to notify them of control information, state changes and similar information about containers and applications running in the platform.

### SUMMARY

In one embodiment, a method is implemented by an event service of a platform. The platform executes a set of containers and component services to support the set of containers. The method tracks subscribers for events and facilitates distribution of the events to the subscribers. The events include information about changes to the state of at least one of the set of containers, where subscribers are processes in communication with the platform. The method includes receiving, at the event service, a subscriber request to subscribe for events of a container from the set of containers, receiving, at the event service, an event from a component service in the set of component services of the platform, and sending, by the event service, the event to the subscriber.

In another embodiment, a computing device is configured to execute the method to implement an event service of a platform. The platform executes the set of containers and component services to support the set of containers. The method tracks subscribers for events and facilitates distribution of the events to the subscribers. The events include information about changes to the state of at least one of the set of containers, where subscribers are processes in communication with the platform. The computing device includes a non-transitory computer-readable medium having stored therein the event service, and a processor. The processor is configured to execute the event service. The event service receives a subscriber request to subscribe for events of a container from the set of containers, to receive an event from a component service in the set of component services of the platform, and to send the event to the subscriber.

A further embodiment, a non-transitory computer-readable medium is provided to store instructions, which when executed by a computing device, cause the computing device to perform a method implemented by an event service of a platform. The platform executes a set of containers and component services to support the set of containers. The method tracks subscribers for events and facilitates distribution of the events to the subscribers. The events include information about changes to the state of at least one of the set of containers, where subscribers are processes in communication with the platform. The method causes the computing device to perform operations including receiving, at the event service, a subscriber request to subscribe for events of a container from the set of containers, receiving, at the event service, an event from a component service in the set of component services of the platform, and sending, by the event service, the event to the subscriber.

### BRIEF DESCRIPTION OF THE DRAWINGS

The invention may best be understood by referring to the following description and accompanying drawings that are used to illustrate embodiments of the invention. In the drawings:

FIGS. 1A and 1B are diagrams of one embodiment of a network of computing devices functioning as platform including a set of server hosts to manage a set of containers.

FIG. 2A is a diagram of one embodiment of the event management system in a platform.

FIG. 2B is a diagram of one embodiment of the components of the event management system and event service of the platform.

FIG. 3 is a flowchart of one embodiment of the process for event subscription management.

FIG. 4 is a flowchart of one embodiment of the process for event distribution management.

FIG. 5 is a flowchart of one embodiment of the event management process as implemented by the event service.

### DETAILED DESCRIPTION

The following description describes methods and apparatus for event management in a platform providing a container management system. The embodiments provide an event-driven and policy controlled process for managing and monitoring containers in the platform to provide real-time feedback about the status and condition of the containers running on the platform to subscribers of the container. Events are distributed to the subscribers based on the policies defined for each container and/or subscriber. Events are generated for life-cycle changes of a container as well as for current resource usage metrics for a container or application with relation to the host running that container and/or application. These metrics can be associated with a container or application where metadata is present in the platform that associates the container and/or application to the resources being utilized on a host. The embodiments provide subscribers with real-time state information for each container and/or application. The subscribers can select to subscribe to specific containers or defined groups of containers.

In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

The prior art has a number of limitations and disadvantages. The two common approaches available in the existing container management systems for monitoring the state and reporting on the condition of containers in a platform is either to provide a centralized repository of status information that can be queried or to provide a control plane event stream. The centralized system has the disadvantage that it has to be polled with requests, instead of automatically providing a stream of events. This makes any solution based the centralized system approach less efficient in operation and more tedious to code for all applications and components relying on it. Polling and querying create additional load on the resources of the system in comparison to the automated streaming.

The event based implementations in contrast do not have sufficient authorization hooks so events can be richly filtered based on the identity of the client. In addition, these event distribution frameworks also do not include resource use information that allows the caller to implement auto-scale applications, or resource use applications.

The embodiments overcome these limitations of the art. The embodiments provide an event-driven and policy controlled process for managing and monitoring the containers in a distributed system environment. In the embodiments, the event-driven approach, built right into the platform, provides real-time feedback about containers running on the platform to subscribers of the container events based on the policies defined on the containers and/or subscribers. Events are generated for life-cycle changes of a container as well as for current resource usage metrics by the host of a container and have metadata that can be associated to a specific container in the system. This provides subscribers the real-time state of a container. In addition, the subscribers can choose to subscribe to a group of containers or a specific container if authorized by policy.

An event driven and policy controlled approach of managing container information provides various advantages over the prior art workload management using third party tools running alongside containers. The embodiments, enable events to be generated from the platform and hosts associated with the platform itself which are controlling and running containers, respectively. That makes events reliable for the subscribers for taking actions with no false-positives. In addition, the embodiments provide that subscribers are properly authenticated and authorized against policy for access to events before events are streamed to them. This provides security against unauthorized information being leaked to subscribers through events which are purposed for internal control clients only. The further advantages include that the embodiments provide for a container life cycle can be monitored and managed by listening to events generated for the container start, shutdown, scale up/down, transfer to new host system and similar container actions. These events can be used to keep applications running in the containers with zero downtime by taking proactive actions on containers based on the reported events. The embodiments provide a system that emits events at fixed intervals for each container to provide continuous resource usage information for a given container. These can be used to monitor the resources used in a datacenter, where hundreds of hosts are running thousands of containers in a distributed system environment. These events can be used for cost analysis and future capacity addition to data centers for optimal resource utilization.

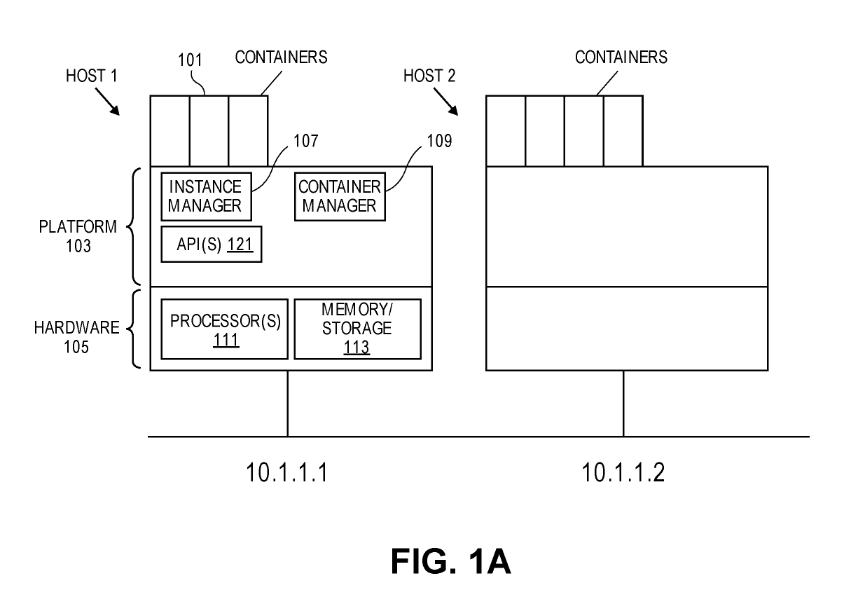

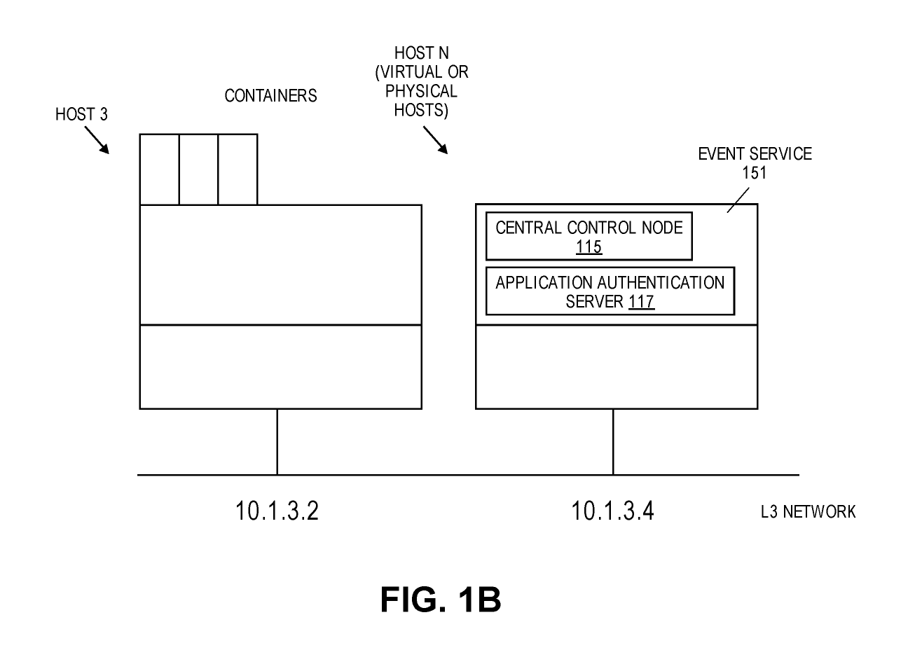

FIGS. 1A and 1B are diagrams of one embodiment of a network of computing devices functioning as platform including a set of server hosts to manage a set of containers. The FIGS. 1A and 1B provide one example of a set of computing devices that implement a platform providing a container management system. In other embodiments, the platform may be implemented by a single computing device with any configuration of hardware, while in further embodiments, the components of the platform may be distributed in other combinations and permutations as would be understood by one of skill in the art. In the example embodiment, the computing devices (Host(s) 1-N) are connected with one another over a local area network in this example an L3 network. In other embodiments, the computing devices can be connected over any type of network, interconnect or communication system.

The computing devices (Host(1-N) can have similar or varied computing resources, including differing processing capabilities, storage capabilities and similar physical hardware differences. While the examples are primarily discussed in terms of physical computing devices serving as hosts, one skilled in the art would understand that additional levels of virtualization are possible such that the platform may execute on a set of virtual hosts. For sake of clarity, the hosts are discussed as physical computing devices.

Each of the computing devices includes hardware 105 comprising a set of one or more processor(s) 111 (which can be any type of general purpose of application specific processors), network interface controller(s) (NICs; also known as network interface cards) (which include physical and virtual interfaces), non-transitory machine readable storage media 113 having stored therein software including the software that implements the embodiments described herein, and similar components. During operation, the processor(s) 111 execute the software to instantiate the platform 103 including any number of constituent components such as an instance manager 103, container manager 109, application programming interfaces (APIs) 121 and similar components, as well as one or more sets of one or more applications. The embodiments may use different forms of virtualization. For example, in one embodiment the platform may encompass the kernel of an operating system (or a shim executing on a base operating system) that allows for the creation of multiple instances called software containers or simply ‘containers’ 101 as used herein that may each be used to execute one (or more) of the sets of applications supported by the platform, where the multiple containers 101 (also called virtualization engines, virtual private servers, or jails) are user spaces (typically a virtual memory space) that are separate from each other and separate from the kernel space in which the operating system is run; and where the set of applications running in a given container or user space, unless explicitly allowed, cannot access the memory of the other containers or processes. In another embodiment the platform encompasses a hypervisor (sometimes referred to as a virtual machine monitor (VMM)) or a hypervisor executing on top of a host operating system, and each of the sets of applications is run on top of a guest operating system within an instance called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In further embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 105, directly on a hypervisor (in which case the unikernel is sometimes described as running within a LibOS virtual machine), or in a software container, embodiments can be implemented fully with unikernels running directly on a hypervisor represented by platform 103, unikernels running within software containers represented by instances 101, or as a combination of unikernels and the above-described techniques (e.g., unikernels and virtual machines both run directly on a hypervisor, unikernels and sets of applications that are run in different software containers).

While embodiments of the invention are illustrated with reference to containers 101, alternative embodiments may implement this correspondence at a finer level granularity (e.g., line card virtual machines virtualize line cards, control card virtual machine virtualize control cards, etc.); it should be understood that the techniques described herein with reference to a correspondence of instances also apply to embodiments where such a finer level of granularity and/or unikernels are used.

In certain embodiments, the platform includes a virtual switch that provides similar forwarding services as a physical Ethernet switch. Specifically, this virtual switch forwards traffic between containers 101 or instances and the NIC(s), as well as optionally between the containers 101 or instances; in addition, this virtual switch may enforce network isolation between the various components of the platform that by policy are not permitted to communicate with each other (e.g., by honoring virtual local area networks (VLANs)).

In some embodiments, hosts 1-N may communicate via a virtual network, which is a logical abstraction of a physical network that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

The platform 103, as discussed above can include various components including an instance manager 107, event services 151, various APIs 121, a central control node 115, an application authentication server 117 and similar components. This listing is not intended to be exhaustive, rather it sets forward those components most directly affected by the processes and embodiments described herein. These components can be spread across any combination of the hosts 1-N in any combination and permutation. Some components, such as the instance manager 107 may have instances on each host, while others such as the application authentication server 117 may be present in only a subset of the hosts.

The instance manager 107 may be responsible for generating processes and jobs in the platform. The instance manager 107 can facilitate the instantiation of applications and containers. APIs 121 are sets of functions that applications, user (e.g., via a command line interface, terminal or similar interface) and similar entities utilize to request resources of the platform including hardware 105. These functions, when invoked, are often referred to as ‘calls’ to the API. Some or all of these APIs can be considered secure APIs that require authentication of the requester before the requests are processed. The authentication is generally tied to a set of permissions or an authorization set of a user who has a set of user credentials that in turn can form or generate a user token. The user credentials or user token can be processed by an authentication server such as the application authentication server 117 to verify that the user credential or the user token are valid or authorized.

A central control node 115 can manage the intercommunication and coordination of the various hosts 1-N to implement the functions of the platform. The platform when distributed can have a centralized or distributed control organization. Where centralized, the central control node 115 can manage the components and communication between the components of the platform.

The event services 151 can manage the distribution of events to a set of subscribers as well as the subscription process where a client, application, component or similar entity request to receive information about a particular container, application or similar component of the platform. A ‘subscriber,’ as used herein refers to any application, process or program that is executed by the platform or that is in communication with the platform that seeks to receive status updates in the form of event notifications. The event service 151 can query the authentication server 117 or similar entity to authenticate subscribers. Once authenticated, a subscriber will be automatically forwarded events from the container and/or application for which the subscription was registered if the subscriber is authorized to receive the events.

The platform can support any number of containers 101 distributed across any number of the hosts 1-N and in any distribution or organization of the containers 101. The containers can be fixed to a particular host or can be configured by the platform to be capable of being moved, for example for load balancing, across the set of hosts 1-N. The containers can have varying user space sizes, accessible resources and similar variations in characteristics.

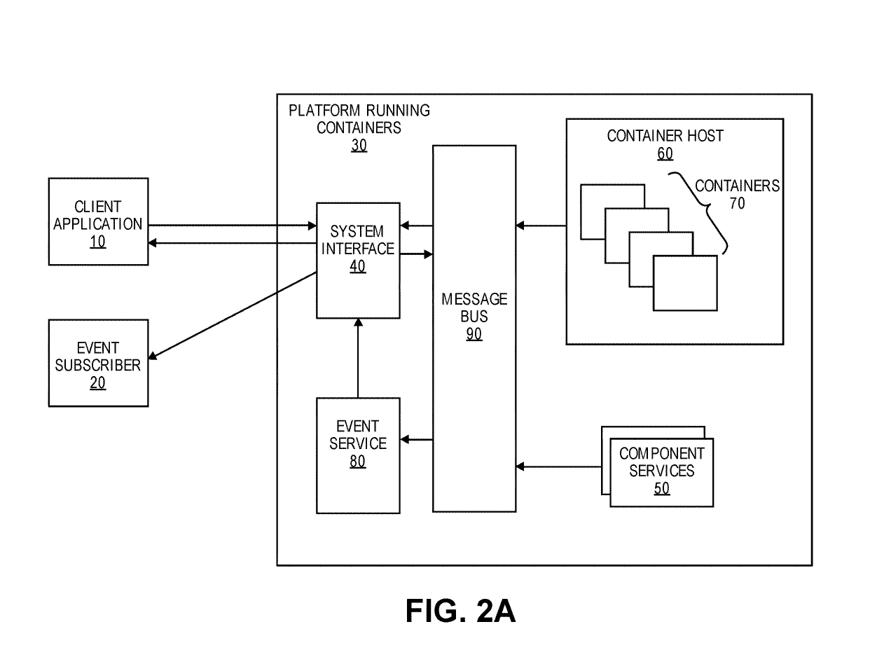

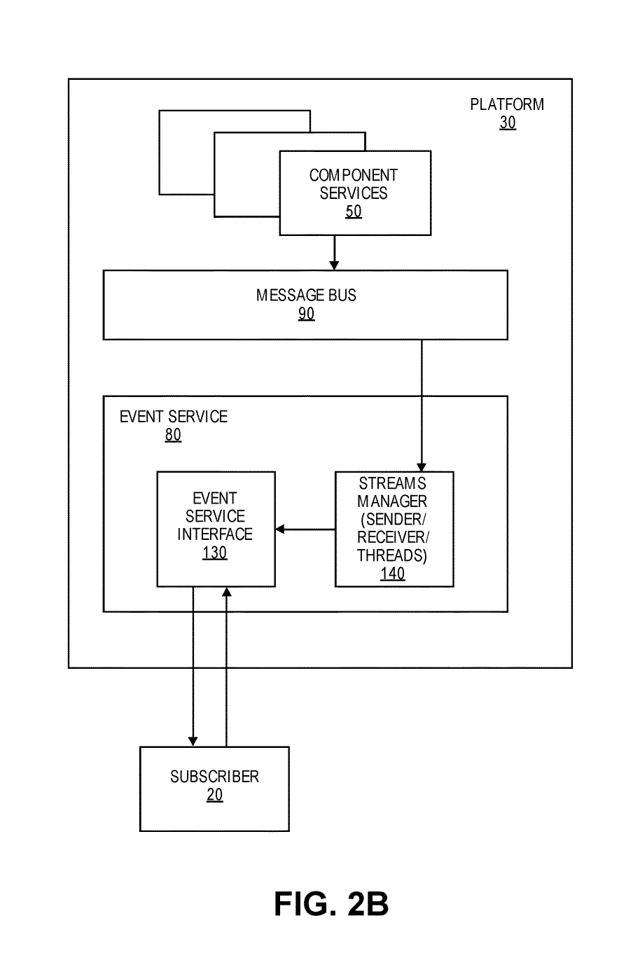

FIG. 2A is a diagram of one embodiment of the event management system in a platform. The diagram illustrates the platform 30 as an abstract communicating with a set of client applications 10, where the client applications 10 are authorized to access and operate on containers via the system interface 40 and can obtain container 70 and/or application information via the event services 80, which as part of an event management and monitoring platform, can manage and monitor containers 70 in real-time and take proactive actions on containers by subscribing to events pertaining to state and computing resource usage of a set of containers 60 with proper authentication and authorization. A ‘set,’ as used herein refers to any positive whole number of items including one item. Similarly, in addition to client applications 10, event subscribers 20 that are non-client applications can also obtain event information via the event service 80.

Events are emitted by the platform component services 50 at various stages of changes in the state of containers 70 controlled by the platform 30. Component services 50 are processes executed by the platform that support interaction between the containers 70 and an operating system, container host, hypervisor and/or hardware resources and components of the platform. If events are persisted by the event service 80 then it can provide the audit trail of container state and the interaction with other containers 70 in the platform 30 or with outside applications. Moreover, container resource usage events can be used as triggers for other applications to dynamically reposition the containers 70 across machines which are running these containers for optimal resource utilization.

The components of the platform that implement and support the containers 70 and other platform components 50 that handle requests from users to take actions on containers (e.g., create, modify or destroy) can generate events related to the changes created for a given container 70. While processing a request affecting a container, the platform components create and send the relevant events on a distributed and highly available message bus 90. The event service 80 is connected to the message bus 80 and collects the events and distributes them across multiple subscribers 20 and client applications 10 after applying authorization parameters, defined by policy, and associated with the subscriptions. These parameters provide authorization semantics to events being emitted external to the platform to maintain system and application security.

The platform 30 that provides capabilities to run and manage containers can comprise of multiple components 50 running as service. A service program which implements a component is configured with parameters to generate events for a container 70. A specific component service, i.e., the event service 80 is implemented to collect, authorize and serve events to the event subscribers 20.

The platform 30 and its constituent components can be implemented in any computer programming language based on a component service model. The platform 30 provides the capability to start, stop, update and scale containers 70 across a distributed computing environment (i.e., a set of hosts).

FIG. 2B is a diagram of one embodiment of the components of the event management system and event service of the platform. The diagram illustrates the components of the event service 80 in greater detail. The event service 80 starts with some configured parameters to connect to distributed container management and monitoring platform 30 via the message bus 90 to receive events from component services 50. The event service 80 is able to run and manage hundreds of subscribers 20 and similar entities at a time and can manage separate event streams for each subscriber 20.

A subscriber 20 subscribes to events pertaining to a single container or a set of containers using a unique resource identifier or a regular expression containing at least a partial container identifier which is common across set of containers. Once successfully subscribed, a two-way connection is opened between subscriber 20 and event service 80 to send and receive data. Both, subscriber 20 and event service 80 can close the connection by sending messages to each other over a well-defined protocol. A user or similar entity requests and action to be performed on a container (e.g., via an API of the platform), which starts/stops/updates a container. The component services of the platform 30 publish events at various stages of the implementation of the received request. The publication of the events with information about each stage of the implementation of the request are published to a message bus 90, which is used by the event service 80 to capture these events. The event service 80 matches container identifiers in the events with the subscriber's container identifier expressions and authorizes subscribers for the received events (i.e., the authorization of the subscriber is authenticated via an authentication server or similar service). If the subscriber is authorized for a given event, then the events are published to the respective authorized subscribers 20 over the respective two-way connection.

The event service includes an event service interface 130 and a streams manager 140. Event service 80 program runs multiple threads to manage event streams for subscribers. For each subscriber connected, the event service 80 runs one receiver thread and one sender thread. The receiver thread receives events over a message bus 90 from component services 50 of the connected platform 30. The sender thread for a stream in the event service program sends events over the two-way connection to subscriber 20. In one embodiment, the management of the two-way connection is handled by the event service interface 130, which also communicates with a stream manager to obtain events to be sent to each of the subscribers 20. The stream manager 140 manages the sender and receiver threads and is connected with the messenger bus 90 to receive the events from the component services 50.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

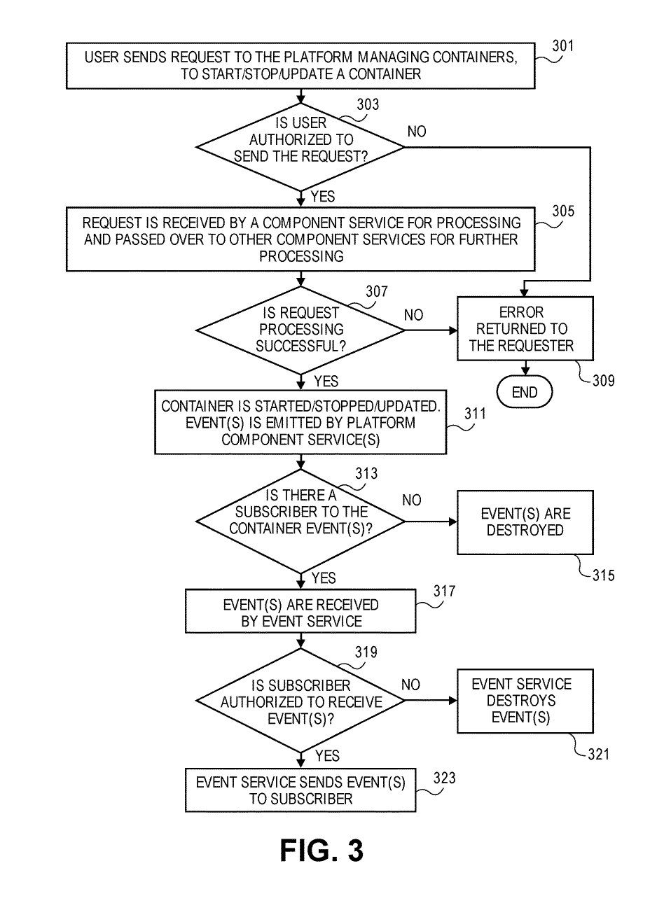

FIG. 3 is a flowchart of one embodiment of the process for event subscription management. FIG. 3 provides an overview of one embodiment of the process for event subscription implemented by the platform. The process is responsive to a user or similar entity sending a request to the platform where the request affects the management of containers supported by the platform (Block 301). The request may be an API call or similar request. The caller can be a user (via a command line prompt, console or similar interface) or an application in communication with the platform. A check is made by the platform whether the user is authorized to send the request that affects the containers (Block 303). The request can affect the platform by causing the start-up or creation of a container and/or application, by stopping or killing a container and/or application, or by modifying or updating a container and/or application. If the caller is not authorized to send the request that was received, then the process may return an error message or similar notification to the requester (Block 309). The error message may indicate that the user or requester does not have authorization for the request and/or the affected container. Authorization may be determined by an authentication server of the platform.

However, if the request is authorized, the request may be passed to a component service of the platform for further processing and implementation (Block 305). This processing by the component services can include the starting/creation, stopping/destruction or modification of at least one container and/or application. After the request is processed, a check may be performed to determine an outcome of the request (Block 307). If the request was not successfully carried out, then the request may be retried or an error message may be returned to the requester indicating a cause or type of error leading to the failure of the request.

If the request processing is successful, then the process may generate an event that correlates with the outcome of the request (Block 311). The component service implementing the request can generate an event that includes information about the starting/creation, stopping/destruction, or modification of a designated container or set of containers. The event may be published by the respective component services via a messaging bus or similar interface. The event may then reach the event services of the platform via the messaging bus. The event services then can determine whether any subscriber exists for the container and/or application associated with the event (Block 313). If there are no subscribers for the affected container or application, then the event can be safely destroyed (Block 321). However, if there are entities that have subscribed for a given container and/or application then for each subscriber an event notification is sent via the event services and messaging bus.

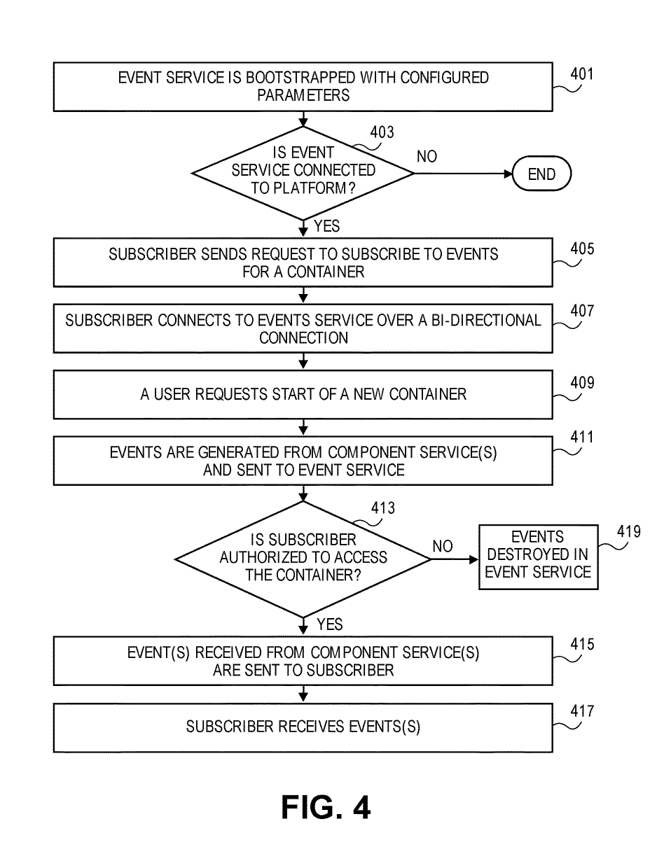

FIG. 4 is a flowchart of one embodiment of the process for event distribution management. Event distribution management as implemented by the platform can be responsive to the startup of the event services and receipt of a subscription request. The event distribution management and event notification process can be a “real-time” process. In this context, the process is “real-time” as the events are generated by component services and distributed to event subscribers as they occur, without unnecessary delay.

The event service can be bootstrapped or similarly initiated as a component of the platform at the system startup or at any time while the platform is operational (Block 401). As part of the startup process the event service may check whether it is properly connected to the platform and the component services (Block 403). This can include a check of proper operation and connection with the messaging bus. If there is not proper connectivity then the event service can be closed or similarly shut down.

Where the event service has been properly established and in communication with the component services of the platform, the event service may idle while waiting to receive a subscriber request to receive events for a particular container and/or application (Block 405). The container and/or application can be identified by any locally or globally unique identifier including any type of uniform resource identifier. The event service can receive any number of subscription request for each requesting entity, which can be any external or internal (relative to the platform) application or interface. The subscription can in some cases also identify the types of events for which notification is requested, which can be any subset of the entire set of possible event types in a given platform.

The subscriptions requests can be serviced by establishing a bi-directional connection between the event service and the subscriber (Block 407). In some cases, a dedicated thread or set of threads to service each subscription or set of subscriptions is established. The event service continues to idle to receive more subscription requests or as illustrated a request may be received by the platform to start/end/update or similarly affect the operation of a container (Block 409). The request to affect a container is independent of the subscription process, but each has an indirect affect on the other. Events are then generated by the component services in the process of servicing the request to start/end/update a container or set of containers (Block 411). The events are published via the messaging bus by the component services where the event service receives the events and performs a check to determine if subscribers who have subscribed to events for a particular container and/or application are authorized to access the container and/or application (Block 413). Being able to access the container and/or application is an indirect manner of determining authorization for receiving event notifications for the container and/or applications. In other embodiments, the determination is more directly a check on the authorization of particular event types or sources. Where there is no authorization for the container/application/event by any subscriber, then the event service may destroy a given notification that is therefore unneeded. If there is at least one authorized subscriber, then the events received from the container and/or application are then forwarded to the subscriber (Block 415). The subscriber will then subsequently receive the forwarded events and can utilize them for any purpose.

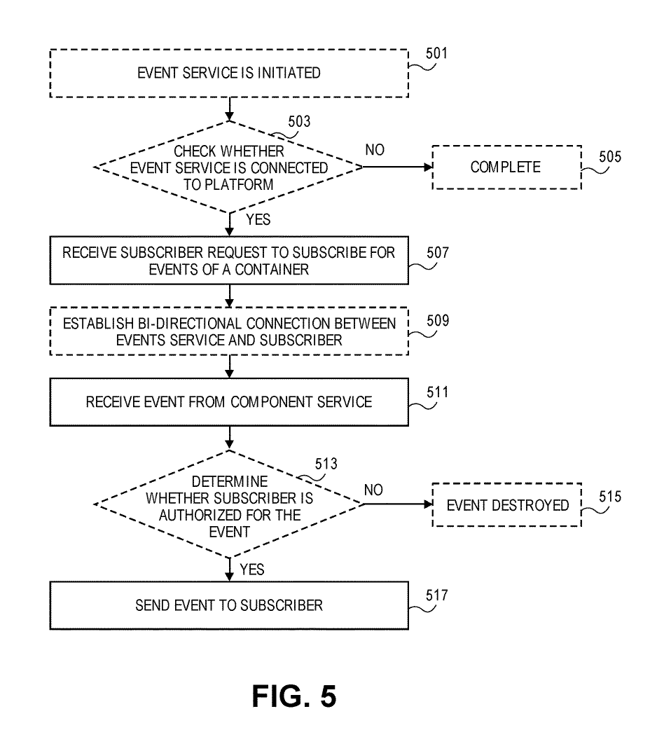

FIG. 5 is a flowchart of one embodiment of the event management process as implemented by the event service. The event service interacts with subscribers and the messaging bus to perform its role in the event notifications process. The event service process is initiated when the event service itself is initiated (Block 501) either at platform startup or at any subsequent time while the platform is operational.

The event service then checks whether it is properly connected with the platform (Block 503). This can include checking connection to the messaging bus and the set of containers maintained by the bus as well as the component services. Where there is not a proper connectivity then the event service can be terminated or restarted (Block 505). If the event service is successfully instantiated and connected to the platform, the event service waits for a subscriber request to be received and then begins the process of monitoring the events requested specifically for that subscriber generated by an identified container and/or application (Block 507). The event service establishes a bi-directional connection between the events service and a subscriber (Bock 509). Each direction may be managed by a separate thread or set of threads such as a sender thread and a receiver thread.

Once the subscriber is properly connected and when an event from a container and/or application for which the subscriber has requested is issued, then the even service monitors the messaging bus for the events associated with the subscription for the identified container and/or application. After the monitoring begins an event from the monitored container and/or application is received (Block 511). A check is then made wither the subscriber has the proper authorization to access the event or the container and/or application associated with that event (Block 513). If proper authorization is not determined to exist for any subscriber, by a check with an authentication server or similar source, then the received event is destroyed. If there is a subscriber that is properly determined to be authorized, then the event is sent to each of the authorized subscribers (Block 517). The event service can continue to receive or update subscription requests as well as service event distribution as long as the platform and the event service is operational.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method implemented by an event service of a platform, the platform executing a set of containers and component services to support the set of containers, the method to track subscribers for events and facilitate distribution of the events to the subscribers, the events including information about changes to the state of at least one of the set of containers, where subscribers are processes in communication with the platform, the method comprising:
receiving, at the event service, a subscriber request to subscribe for events of a container from the set of containers;
receiving, at the event service, an event from a component service in the set of component services of the platform; and
sending, by the event service, the event to the subscriber.

2. The method of claim 1, further comprising:
establishing a bi-directional connection between the event service and the subscriber.

3. The method of claim 1, further comprising:
establishing a send thread within the event service to communicate with the subscriber; and
establishing a receive thread within the event service to monitor a messaging bus.

4. The method of claim 1, further comprising:
determining, by the event service, whether the subscriber is authorized to receive the event; and
discarding, by the event service, the event where the subscriber is not authorized.

5. The method of claim 4, wherein the determining of whether the subscriber is authorized, further comprises:
querying an authentication server using user credentials or user token to verify that the user credential or the user token are valid or authorized.

6. The method of claim 1, further comprising:
determining whether there are any subscribers to events of the container; and
discarding events of the container where there are no subscribers.

7. A computing device to execute a method to implement an event service of a platform, the platform executing a set of containers and component services to support the set of containers, the method to track subscribers for events and facilitate distribution of the events to the subscribers, the events including information about changes to the state of at least one of the set of containers, where subscribers are processes in communication with the platform, the computing device comprising:
a non-transitory computer-readable medium having stored therein the event service; and
a processor, the processor to execute the event service, the event service to receive a subscriber request to subscribe for events of a container from the set of containers, to receive an event from a component service in the set of component services of the platform, and to send the event to the subscriber.

8. The computing device of claim 7, wherein the processor further to execute the event service to establish a bi-directional connection between the event service and the subscriber.

9. The computing device of claim 7, wherein the processor further to execute the event service to establish a send thread within the event service to communicate with the subscriber, and establish a receive thread within the event service to monitor a messaging bus.

10. The computing device of claim 7, wherein the processor further to execute the event service to determine whether the subscriber is authorized to receive the event, and to discard the event where the subscriber is not authorized.

11. The computing device of claim 10, wherein the determining of whether the subscriber is authorized, further includes the processor executing the event service to query an authentication server using user credentials or user token to verify that the user credential or the user token are valid or authorized.

12. The computing device of claim 7, wherein the processor further to execute the event service to determine whether there are any subscribers to events of the container, and to discard events of the container where there are no subscribers.

13. A non-transitory computer readable medium having stored therein instructions, which when executed by a computing device, cause the computing device to perform a method implemented by an event service of a platform, the platform executing a set of containers and component services to support the set of containers, the method to track subscribers for events and facilitate distribution of the events to the subscribers, the events including information about changes to the state of at least one of the set of containers, where subscribers are processes in communication with the platform, the method causing the computing device to perform operations comprising:
receiving, at the event service, a subscriber request to subscribe for events of a container from the set of containers;
receiving, at the event service, an event from a component service in the set of component services of the platform; and
sending, by the event service, the event to the subscriber.

14. The non-transitory computer-readable medium of claim 13, having further instructions stored therein, which when executed cause the computing device to perform operations further comprising:
establishing a bi-directional connection between the event service and the subscriber.

15. The non-transitory computer-readable medium of claim 13, having further instructions stored therein, which when executed cause the computing device to perform operations further comprising:
establishing a send thread within the event service to communicate with the subscriber; and
establishing a receive thread within the event service to monitor a messaging bus.

16. The non-transitory computer-readable medium of claim 13, having further instructions stored therein, which when executed cause the computing device to perform operations further comprising:
determining, by the event service, whether the subscriber is authorized to receive the event; and
discarding, by the event service, the event where the subscriber is not authorized.

17. The non-transitory computer-readable medium of claim 16, wherein the operation of determining of whether the subscriber is authorized, further comprises:
querying an authentication server using user credentials or user token to verify that the user credential or the user token are valid or authorized.

18. The non-transitory computer-readable medium of claim 13, having further instructions stored therein, which when executed cause the computing device to perform operations further comprising:
determining whether there are any subscribers to events of the container; and
discarding events of the container where there are no subscribers.
